(19) United States
(12) Patent Application Publication
(10) Pub. No.: US 2005/0261000 A1
(43) Pub. Date: Nov. 24, 2005

(54) Method for supplying persons with updated, location-dependent information by means of acoustic and/or optical information

(76) Inventor: Ralph Heck, Dusseldorf (DE)

Correspondence Address: WHITE & CASE LLP;PATENT DEPARTMENT, 1155 AVENUE OF THE AMERICAS, NEW YORK, NY, 10036, US

(21) Appl. No.: 10/433,662

(22) PCT Filed: Dec. 7, 2001
(86) PCT No.: PCT/DE01/04578

§ 371 Date: Oct. 30, 2003

(30) Foreign Application Priority Data
Dec. 8, 2000 (DE) 10061507.4

(51) Int. Cl. H04Q 7/20

(52) U.S. Cl. 455/456.1

(57) ABSTRACT

According to said method, each person is allocated a mobile receiver, which contains information stored in a memory. A respective code signal is assigned to said information. One or more first transmitters transmit(s) code signals in respective areas that are spatially limited. The receiver has reproduction means for reproducing the information stored in the memory and reproduces the information upon receipt of the code signal assigned to said information. To simplify the update of the information, second transmitters transmit information signals and information concerning the assignment of code signals in spatially limited areas, said information being saved by the receivers. The ready-to-receive state of the receivers for the information signals is temporally limited and is established without the intervention of the person receiving the information. The method can thus be carried out with an extremely low energy consumption.

The invention relates to a method for supplying persons with up-to-date, location-dependent information by means of audio and/or visual information.

DE 35 17 818 C2 discloses a method for supplying the visitors to exhibitions with information, in which the visitors to an exhibition are informed about an exhibit by means of wireless signal transmission. Each exhibit has an associated transmitter; every visitor carries a receiver around. The transmitter continuously radiates repetitive code signals associated with the exhibit. The receiver carried by the visitor stores information about the exhibits in a memory. The code signals trigger audio and/or visual reproduction of a particular information item from the memory in the receiver.

The known method has the drawback that the information stored in the receiver's information store cannot be continuously updated. It is entirely possible for the method to be applied for use in a permanent exhibition, a museum or the like. However, it cannot be transferred to the supply of information to consumers in consumer markets, such as supermarkets, for example.

By way of example, special offers in a supermarket need to be regularly updated. The advertising of particular products needs to be stopped as soon as the warehouse stock has been sold. The previously known method does not allow this with a feasible level of involvement, since this would require the memory to be supplied with updated information by every receiver individually.

There is therefore a need for a method which allows persons to be supplied with information on a location-dependent basis and in which the information can be updated without any great involvement.

The invention proposes a method for supplying persons with up-to-date, location-dependent information by means of audio and/or visual information, where each person is allocated a mobile receiver. A memory in the mobile receiver contains stored information which is respectively associated with a code signal. One or more first transmitters transmit code signals in respective physically limited areas. The receiver has reproduction means for reproducing the information stored in the memory and reproduces said information when it receives the code signal associated with the information. The inventive method is characterized in that second transmitters transmit information signals and associated code signals, which the receivers store, in physically limited areas.

In line with the invention, the receiver can be supplied with information via second transmitters, which transmit information signals and associated code signals. These signals are received by the receiver and are stored in a memory. The second transmitters are preferably arranged at places where the receivers spend a relatively long time. These can be, by way off example, locations at which the persons to be informed spend a relatively long time or else the locations at which the receivers are stored when they are not being used. The second transmitters preferably transmit RF or UHF signals.

Preferably, the information is transmitted a plurality of times in succession by the second transmitters and is stored by the receiver only if the successive signals are identified as being the same. This ensures that incomplete or incorrect information is not stored if reception is disrupted in the interim or if a receiver is suddenly removed from the transmission range of a second transmitter. This allows the operating safety of the system to be significantly improved.

The persons can move freely with the receivers through the space. Those locations at which information is intended to be provided specifically have first transmitters arranged at them which transmit a code signal. Preferably, this is an IR signal. When the code signal is received by the receivers, an information item associated with the code signal is reproduced from the receiver's memory. This can be done audibly through loudspeakers and/or visually using a display.

To save energy, it is useful to limit the receiver's reception standby for information signals. This can be done, by way of example, by virtue of the receiver being ready to receive only when it is not in the range of the second transmitters. As soon as the receiver receives a signal from a first transmitter, the receiver's reception activity for signals from the second transmitters can be turned off. Reception standby can be restored through the passage of time, for example. Alternatively, a particular code signal can result in the reception standby being turned on or off. When used in areas in which there is an entrance and an exit, by way of example, the entrance area can contain a first transmitter which transmits a code signal which turns off the reception standby for information signals. In the exit area, a further first transmitter can then transmit a code signal for renewed reception standby. Other criteria for reception standby are likewise conceivable, however, such as the time of day or a mechanical barrier, such as the return lock on a shopping cart.

To be able to use the inventive method advantageously in a consumer market, such as a supermarket, the receivers are preferably coupled to a shopping cart. This can be implemented by arranging them in the handle of the shopping cart, for example. A panel can be provided thereon which is particularly well suited to a display.

An arrangement which is suitable for the inventive method comprises one or more first transmitters, which can transmit code signals, one or more second transmitters, which can transmit information signals and associated code signals, and receivers, which can receive and store the signals from the second transmitters and, when a code signal is received from a first transmitter, can reproduce the information signal associated with the code signal from the memory.

The inventive method is explained in more detail below with reference to an example:

The aim is to supply the customers in a supermarket with information about special offers. This is intended to involve the conveyance of specific information about the respective product group in whose area the customer is currently situated.

For this purpose, shopping carts in the supermarket are equipped with receivers. The receivers are arranged in the handle of the shopping cart and are powered by batteries or storage batteries. The receivers have a display on which text and graphical information can be reproduced.

A second transmitter is arranged such that the information signals which it transmits can be received by the receivers on the shopping carts which are at the parking place for shopping carts. The second transmitter radiates information in order to load information into the memories in the receivers. This is individual information relating to products which are respectively associated with a product group. By way of example, it can be information about special offers. Each individual information item has an associated coding. Each stored information item can be individually overwritten as a result of the reception of new information from the second transmitter which is associated with the same coding.

The second transmitter radiates each information item five times in succession. Only if five successive information signals are received identically is the information item stored in the memory in the receivers overwritten with the new information item. This achieves a high level of operating safety for the system. Misinformation or operating faults are avoided.

The second transmitter operates in the UHF range, ISM (industry, science, medicine) band 433 MHz or 886 MHz. The signals are transmitted in the morning before the supermarket opens, when all the shopping carts are in the parking place, in order to store up-to-date information. During the day, all or some of the information can be updated as required. The shopping carts periodically returning to the parking place can be continually provided with up-to-date information.

When a customer enters a supermarket, fetches a shopping cart from the parking place and enters the sales area, he enters the area of the first transmitters, which are infrared transmitters. These transmitters continuously radiate code signals. The code signals are respectively associated with an information item in the memory in the receiver. By way of example, after the supermarket entrance, the customer enters the fresh fruit area. To provide information about special offers, in this specific product group, the receiver receives the corresponding code signal and then shows the special offer information on the display. When the information has been shown in its entirety, the receiver is ready to receive further code signals again. While the code signal does not change, the same information is shown a plurality of times or is maintained on a display. When the customer goes into the next product group, the transmitter receives another code signal from the first transmitter for this product group and shows the corresponding information.

If an offer is no longer available, misinformation can be prevented by virtue of the information being updated in the memory in the receivers. Until all the receivers have been updated, misinformation can immediately be prevented by temporarily turning off the second transmitter in question.

When he has finished shopping, the customer returns the shopping cart to the parking place. The offer can be updated by the second transmitters' information signals which can be received there.

The receivers are operated by storage battery or batteries. To save power, it is advantageous to turn off the reception activity, particularly for the information signals, while it is not required. This is done by virtue of the entrance to the supermarket having a first transmitter which transmits a code signal prompting the receiver to stop the reception activity for information signals. Preferably, this is simultaneously the code signal for the first information item, such as the welcome for the customer. The till area then contains a further first transmitter, whose code signal allows the reception activity to be restarted. Alternatively, the coupling of reception can also be coupled to release of the shopping cart return lock, for example.

1. A method for supplying persons with up-to-date, location-dependent information by means of audio and/or visual information, where each person is allocated a mobile receiver which has a memory containing stored information which is respectively associated with a code signal, where one or more first transmitters transmit code signals in respective physically limited areas, and where the receiver has reproduction means for reproducing the information stored in the memory and reproduces said information when it receives the code signal associated with the information, characterized in that second transmitters transmit information signals and associated code signals, which the receivers store, in physically limited areas.

2. The method as claimed in claim 1, characterized in that the fist transmitters are IR transmitters.

3. The method as claimed in claim 1 or 2, characterized in that the second transmitters are RF or UHF transmitters.

4. The method as claimed in one of claims 1 to 3, characterized in that the second transmitters transmit individual or a plurality of information items with code signals continuously or at prescribed times.

5. The method as claimed in claim 4, characterized in that each information item is transmitted a plurality of times in succession by the second transmitters.

6. The method as claimed in claim 5, characterized in that the receiver stores an information item only if a plurality of successive information signals match.

7. The method as claimed in one of claims 1 to 6, characterized in that the receivers' reception standby for information signals is turned off as soon as the receiver is situated in the transmission range of a first transmitter.

8. The method as claimed in one of claims 1 to 7, characterized in that the receiver is connected to a shopping cart.

9. The method as claimed in one of claims 1 to 8, characterized in that the reproduction means are visual displays and/or loudspeakers.
